(19) United States
(12) Patent Application Publication
(10) Pub. No.: US 2015/0299907 A1
(43) Pub. Date: Oct. 22, 2015

(54) Monofilaments Having Abrasion Resistance, Dimensional Stability, Glideability and Soiling Resistance, Textile Fabrics Comprising Same and Use Thereof

(71) Applicant: Perlon Nextrusion Monofil GmbH, Bobingen (DE)

(72) Inventors: Hans Joachim Brüning, Augsburg (DE); Jürgen Büdenbender, Dormagen (DE); Pascal Heckenbenner, Augsburg (DE)

(21) Appl. No.: 14/680,594

(22) Filed: Apr. 7, 2015

(30) Foreign Application Priority Data
Apr. 16, 2014 (DE) 202014003285.8
Sep. 25, 2014 (DE) 102014014479.8

(51) Int. Cl. D01F 8/14; B65G 15/34; D21F 1/00; D01F 8/12; D01F 8/16

(52) U.S. Cl. CPC D01F 8/14; D01F 8/12; D01F 8/16; D21F 1/0027; B65G 15/34

(57) ABSTRACT

Monofilaments comprising particles of polysiloxane from 10 nm to 200 μm in diameter in a matrix of thermoplastic polymer are provided. The monofilaments are useful in the manufacture of papermachine clothings in particular and are notable for abrasion resistance, dimensional stability, glideability and soiling resistance.

### CLAIM FOR PRIORITY

This application was based on German Application No. DE 20 2014 003 285.8, filed Apr. 16, 2014, as well as German Application No. DE 10 2014 014 479.8, filed Sep. 25, 2014. The priorities of Application No. DE 20 2014 003 285.8 and Application No. DE 10 2014 014 479.8 are hereby claimed and their disclosures incorporated herein by reference.

### TECHNICAL FIELD

The present invention relates to monofilaments useful for producing textile fabrics used in particular in mechanically stressful environments. The textile fabrics produced from the monofilaments of the present invention may preferably be used as cylinder mold for porous papermachine clothing. These are used with particular preference in the forming and drying sections of papermachines.

### BACKGROUND

The bottom layer of forming wires used in the forming section of papermachines is exposed to enhanced wear due to the pressure conditions (suction boxes) prevailing in this section. This is why alternating monofilaments of polyethylene terephthalate (hereinafter also called “PET”) and of polyamide have hitherto been used on the bottom side of these wires. This combination has proved to be more abrasion resistant than purely PET.

It has now been found that the addition of silicone spherules to the base polymer is an excellent way to achieve a significant reduction in the friction and soiling of papermachine forming and drying wires not only in the warp but also in the weft. This obviates in the drying section in particular the previous addition of comparatively costly fluoropolymers to the base polymer. Surprisingly, base polymer hydrolysis resistance is not adversely affected by the addition of silicone polymer.

DE 69609709T2, in the context of enumerating possible additions, mentions that polysiloxanes may be incorporated in monofilaments. The addition of polysiloxanes to monofilaments for papermachine wire screens is also already mentioned in DE 10 2004 054 804 A1 and DE 10 2005 044 435 A1.

The problem addressed by this invention is that of providing a combination of materials which offers very low resistance to glideability, and hence reduces the drive power requirements of the machine, and has soiling resistance.

The problem is solved by providing monofilaments produced from a mixture of selected components.

### SUMMARY OF INVENTION

The present invention provides monofilaments comprising a matrix of thermoplastic polymer and dispersed therein particles of polysiloxane which are from 10 nm to 200 μm in diameter.

The polysiloxane particles may have any desired shape. Examples thereof are particles of rotationally symmetrical shape, in particular spheres, but also of irregular shape. These particles are in the form of micropowders. The diameter of these particles varies in the range from 10 nm to 200 μm, preferably from 0.2 to 50 μm. The stated diameter in the case of particles having varying diameters relates to the largest diameter of the particle.

Preference is given to monofilaments containing spherical polysiloxane particles from 0.2 to 50 μm in diameter.

The dispersed polysiloxane in the matrix polymer is in the form of micropowder. The polysiloxane content of the matrix polymer is generally from 0.001 wt % to 8 wt %, preferably from 0.02 wt % to 5 wt %. The particles form a heterogeneous phase in the matrix polymer. The particles in the matrix polymer may be individual particles and/or aggregates of various individual particles.

The particle content of the monofilament may vary between wide limits. The particle content of the monofilament is typically in the range from 0.01 to 8 wt %, preferably from 0.1 to 5 wt %, based on the mass of the monofilament.

### DETAILED DESCRIPTION

The polysiloxanes used according to the present invention are a group of synthetic polymers wherein silicon atoms are linked via oxygen atoms. The polysiloxanes used according to the present invention are also known as silicones. Linear or mutually crosslinked linear polysiloxanes may be concerned or else polysiloxanes having a cage structure, which are known as silsesquioxanes.

Preference is given to using linear or crosslinked polysiloxanes comprising the repeating structural element —SiR¹R²—O— or silsesquioxanes of the formula R¹SiO_{3/2}, where R¹ is C₁-C₆-alkyl, in particular methyl, and R² is C₁-C₆-alkyl or phenyl, in particular methyl or phenyl.

Very particular preference is given to monofilaments containing polysiloxanes in the form of linear or crosslinked polydimethylsiloxanes or a polymethylsilsesquioxane.

Any spinnable thermoplastic polymer is in principle selectable as thermoplastic matrix polymer. Examples of matrix polymers include thermoplastic polymers from the group of polyesters, polyamides, polyether ketones, polyphenylene sulfides, polyolefins or a combination of two or more thereof.

Polyesters are preferably used as matrix polymers, in particular a polyethylene terephthalate, a polybutylene terephthalate, a dicarboxylic acid-modified polyethylene terephthalate, a dicarboxylic acid-modified polybutylene terephthalate or a combination of two or more thereof.

Particularly preferred polyesters include polyethylene terephthalate or polybutylene terephthalate homopolymers or polyethylene terephthalate or polybutylene terephthalate copolymers. These polymers thus derive from ethylene glycol and/or from butylene glycol as well as from terephthalic acid or its polyester-forming derivatives, such as the dicarboxylic esters or dicarbonyl chlorides and, where appropriate, further dicarboxylic acids or their polyester-forming derivatives.

These thermoplastic polyesters are known per se. Building blocks of thermoplastic copolyesters a) are the abovementioned ethylene glycol or butylene glycol and also the abovementioned dicarboxylic acids or correspondingly constructed polyester-forming derivatives. The main acid constituent of the polyesters of the matrix component are in addition to terephthalic acid, ethylene glycol and/or butylene glycol, if appropriate together with minor proportions, preferably up to 30 mol %, based on the combined amount of dicarboxylic acids, of other aromatic and/or aliphatic and/or cycloaliphatic dicarboxylic acids, preferably with aromatic compounds, e.g., phthalic acid, 4,4″-biphenyldicarboxylic acid or particularly isophthalic acid and/or with aliphatic dicarboxylic acids, e.g., with adipic acid or sebacic acid.

Suitable dihydric alcohols are employable in addition to the ethylene glycol or the butylene glycol (1,4-butanediol) in small amounts, for example up to 30 mol %, based on the combined amount of alcohols. Typical representatives of suitable dihydric alcohols include aliphatic and/or cycloaliphatic diols, for example propanediol, cyclohexanedimethanol or mixtures thereof.

Examples of preferred matrix polymers include copolyesters which, in addition to polyterephthalate units, include further units, these further units being derived from alkylene glycols, in particular ethylene glycol, and aliphatic and/or aromatic dicarboxylic acids, such as adipic acid, sebacic acid, terephthalic acid or isophthalic acid.

Preferably used matrix polymers include polyethylene terephthalate or a dicarboxylic acid-modified polyethylene terephthalate, in particular an aromatic dicarboxylic acid-modified polyethylene terephthalate or an aliphatic dicarboxylic acid-modified polyethylene terephthalate.

Very particularly preferably used matrix polymers include aromatic dicarboxylic acid-modified polyethylene terephthalate, in particular isophthalic acid-modified polyethylene terephthalate or phthalic acid-modified polyethylene terephthalate.

Likewise very particularly preferably used matrix polymers include aliphatic dicarboxylic acid-modified polyethylene terephthalate, in particular an adipic acid-modified polyethylene terephthalate or a sebacic acid-modified polyethylene terephthalate.

The matrix polyesters used according to the present invention typically have solution viscosities (IV values) of not less than 0.60 dl/g, preferably of 0.60 to 1.05 dl/g, more preferably of 0.62-0.93 dl/g (measured at 25° C. in dichloroacetic acid (DCA)).

Polyamides are a further group of preferably used matrix polymers, in particular polyamides derived from aliphatic dicarboxylic acids or their polyamide-forming derivatives and from aliphatic diamines or from aliphatic aminocarboxylic acids or aliphatic lactams.

Particularly preferred polyamides include nylon-6, nylon-6,6, nylon-6,10, nylon-12 and nylon-6,12.

Preferred monofilaments of the present invention are carbodiimide stabilized. The carbodiimide is added to the spinnable composition. Stabilization by carbodiimide addition is particularly preferred for polyester monofilaments.

Preference is given to polyester monofilaments having a free carboxyl group content of not more than 10 meq/kg, preferably not more than 5 meq/kg.

This is attainable by addition of carbodiimide because the latter is an agent for capping free carboxyl groups.

Polyester monofilaments thus additized are particularly stable to hydrolytic degradation and very useful in hot moist environments, for example in papermachines or as filters.

It is very particularly preferable to employ polymeric carbodiimides as stabilizers.

Carbodiimides are commercially available under the trade name of Stabaxol® (Rheinchemie).

The amounts of the individual constituents in the monofilaments of the present invention may vary between wide limits and are selected by a person skilled in the art according to the desired range of properties.

Preference is given to monofilaments wherein the proportion of thermoplastic polymer is from 60 to 95 wt %, the proportion of polysiloxane is from 0.02 to 8 wt % and the proportion of carbodiimide is from 0 to 10 wt %, wherein the quantitative particulars are based on the overall amount of the monofilament.

The invention employs a combination of thermoplastic matrix polymer and polysiloxane particles to endow the monofilaments not only with glideability and soiling resistance but also with good textile-technological properties, in particular a high dimensional stability and also, combined with carbodiimides, excellent resistance to hydrolysis. Fluoropolymers as frequently used in the drying section to reduce soiling are eschewable here, although their use is not foreclosed.

A person skilled in the art selects the components to be used in an individual case. To wit, the components for the monofilament of the present invention must be chosen such that they can be processed at temperatures at which none of the components is subject to any significant decomposition.

The polyester monofilament of the present invention, in addition to the components described above, may additionally comprise further and customary additives. The amount of such additives is typically in the range 0.001 to 10 wt %, based on the overall mass of the monofilament.

Examples of customary additives include antioxidants, UV stabilizers, fillers, pigments, biocides, electroconductivity enhancers, abrasion resistance enhancers, friction-reducing additives, spin finishes, processing aids, plasticizers, lubricants, delusterants, viscosity modifiers, crystallization accelerants or combinations of two or more thereof.

The components needed to produce the monofilaments of the present invention are known per se, partly available commercially or obtainable by processes known per se.

The linear density of monofilaments according to the present invention may vary between wide limits. Examples thereof are 50 to 45 000 dtex, in particular 100 to 5000 dtex.

The cross-sectional shape of the monofilaments according to the present invention is freely choosable, examples being round, oval or n-gonal, where n is not less than 3.

The monofilaments of the present invention are obtainable by processes known per se.

A typical method of production comprises the measures of:
i) mixing the matrix polymer and the polysiloxane particles or the matrix polymer and a masterbatch comprising polysiloxane particles in an extruder,
ii) extruding the mixture of step i) through a spinneret die,
iii) withdrawing the resulting monofilament,
iv) optionally drawing and/or relaxing the monofilament, and
v) winding up the monofilament.

One or more of the components of the monofilament according to the present invention are also usable in the form of a masterbatch. Particularly a carbodiimide masterbatch in polyester is conveniently meterable and mixable into the matrix polymer. The form of a masterbatch can similarly be used to incorporate the polysiloxane particles into the matrix polymer.

The monofilaments of the present invention are subjected to single or multiple drawing in the course of production.

It is particularly preferable to produce the monofilaments by using a matrix polymer comprising a polyester raw material produced by solid state condensation.

After the polymer has been melted and the polymer melt forced through a spinneret die, the hot strand of polymer is quenched, preferably in a water bath, and then subjected to single or multiple drawing, optional setting and winding up, as is known from the prior art for the recited melt-spinnable polymers.

The monofilaments of the present invention are preferably used for producing textile fabrics, particularly woven fabrics, spiral fabrics, non-crimp fabrics or drawn-loop knits. These textile fabrics are preferably used in screens.

The invention accordingly also provides a textile fabric comprising the above-described monofilaments, in particular textile fabrics in the form of a woven fabric, a loop-drawingly knitted fabric, a loop-formingly knitted fabric, a braided fabric or a non-crimp fabric.

The monofilaments of the present invention are usable in any industrial field. They are preferably employed for applications where increased wear and also high mechanical stress particularly in hot moist surroundings is likely. Examples thereof are the use in screen fabrics and filter cloths for gas and liquid filters, in drying belts, for example for production of food items or particularly of paper.

The invention also provides for the use of the above-described monofilaments as papermachine clothing, in conveyor belts and in filtration screens.

It is very particularly preferable to use the monofilaments of the present invention as papermachine clothing in the forming section and/or in the drying section of the papermachine.

For example, these monofilaments are used in the backing weft of forming wire screens in papermachines. This can take the form of 100% as backing weft or as alternating weft (where the recited monofilament alternates with, for example, polyamide monofilaments). The polysiloxane additive, in particular the polymethylsilsesquioxane (PMSQ) additive, has the effect of distinctly increasing glideability and hence of significantly reducing the drive power requirements of the papermachine, resulting in a significant energy saving. The monofilament of the present invention is further more abrasion resistant than comparable monofilaments in polyethylene terephthalate or polyamides without polysiloxane additive.

In a further preferred embodiment, a dispersion of matrix polymer and polysiloxane, in particular PMSQ, further comprises carbodiimide as a hydrolysis stabilizer. As a result, this version is particularly suitable for drying processes in moist surroundings, for example in the drying section of papermachines, and also in other continuous industrial drying and filtration processes.

The retained strength of comparable hydrolysis-stabilized polyethylene terephthalate grades is not reduced by the polysiloxane/PMSQ. A further positive side-effect is the low soiling of the monofilament and/or monofilament fabric due to the hydrophobicity of the polysiloxane/PMSQ.

The present invention is more particularly described by the examples which follow. These examples serve only to elucidate the invention and are not to be construed as limiting it.

### Example 1

The matrix polymer is a commercially available polyethylene terephthalate: AD01 from DuFor Resins B.V., Zevenaar/Netherlands. To add the polysiloxane dispersion, 2.5 wt % of thermoplastic spherules—MB 50-010 from Dow Corning S.A., Seneffe/Belgium—were metered in followed by the addition of 2.5 wt % of Renol Weiβ ATX 406 from Clariant Masterbatches, Lahnstein/Germany.

The three components were mixed before extrusion, then extruded, spun, subjected to multiple drawing under heat and wound up.

The monofilament thus obtained to a nominal diameter of 1.28 mm had the following textile values:

diameter: 1.294 mm

linear density: 17 455 dtex

free thermal shrinkage 180°: 21.8%

linear strength: 33.8 cN/tex

knot strength: 29.1 cN/tex

loop strength: 32.4 cN/tex

elongation at break: 28.4%.

The surface texture obtained is decisive. The spherical calottes of the silicone dispersion form distinct protrusions on the surface. They endow the monofilament with the desired properties, namely glideability and soiling resistance.

### Example 2

Akulon F 136-C1 nylon n-6 commercially available from DSM was used at 98.5 wt %. To this was added 1.5 wt % of thermoplastic polysiloxane spherules: Pellet S from Wacker Chemie.

The two components were mixed before extrusion, then extruded, spun, subjected to multiple drawing under heat and wound up.

Process data and properties of the resulting monofilament are itemized below in tables 1, 2 and 3.

### Example 3

Example 2 was repeated except that the matrix polymer used was 99.0 wt % of a commercially available nylon-6: Akulon F 136-C1 from DSM. The polysiloxane spherules used were 1.0 wt % of PMSQ E+580 from Coating Products. The average diameter of the polysiloxane spherules was 8 μm.

Process data and properties of the resulting monofilament are itemized below in tables 1, 2 and 3.

### Example 4

Example 2 was repeated except that the matrix polymer used was 99.0 wt % of a commercially available polyethylene terephthalate: RT 52 from Invista. The silicone spherules used were 1.0 wt % of PMSQ E+580 from Coating Products.

Process data and properties of the resulting monofilament are itemized below in tables 1, 2 and 3.

### Example 5

Example 4 was repeated except that the matrix polymer used was 97.5 wt % of a commercially available polyethylene terephthalate: RT 52 from Invista. The silicone spherules used were 2.5 wt % of PMSQ: MB50-010 from Dow Corning.

Process data and properties of the resulting monofilament are itemized below in tables 1, 2 and 3.

### Example 6

Example 4 was repeated except that the matrix polymer used was 99.0 wt % of a commercially available polyethylene terephthalate: RT 52 from Invista. The silicone spherules used were 2.5 wt % of thermoplastic silicone spherules: Pellet S from Wacker Chemie.

Process data and properties of the resulting monofilament are itemized below in tables 1, 2 and 3.

### Example 7

Example 4 was repeated except that the matrix polymer used was 93.3 wt % of a commercially available polyethylene terephthalate: RT 12 from Invista. The silicone spherules used were 1.0 wt % of PMSQ E+580 from Coating Products. In addition, 5.0 wt % of a masterbatch of aromatic polycarbodiimide in PET (Stabaxol® KE 9428 from Rheinchemie) and 0.7 wt % of a substituted diarylcarbodiimide (Stabaxol® I LF from Rheinchemie) were used.

Process data and properties of the resulting monofilament are itemized below in tables 1, 2 and 3.

### Comparative Example V1

Example 2 was repeated except that the matrix polymer used was 100 wt % of a commercially available nylon-6: Akulon F 136-C1 from DSM. No thermoplastic silicone spherules were added.

Process data and properties of the resulting monofilament are itemized below in tables 1, 2 and 3.

### Comparative Example V2

Example 4 was repeated except that the matrix polymer used was 100 wt % of a commercially available polyethylene terephthalate: RT 52 from Invista. No thermoplastic silicone spherules were added.

### Comparative Example V3

Example 7 was repeated except that the matrix polymer used was 94.3 wt % of a commercially available polyethylene terephthalate: RT 12 from Invista. No thermoplastic silicone spherules were added. Type and amount of carbodiimide stabilizers were in line with Example 7.

Properties of the resulting monofilament are itemized below in table 3.

Table 1 below itemizes the process data for the monofils from some of the examples described above:

TABLE 1

| | Example No. | | | | | | | |
|---|---|---|---|---|---|---|---|---|
| | V1 | 2 | 3 | V2 | 4 | 5 | 6 | 7 |
| extruder zone 1 | 261 | 261 | 261 | 278 | 278 | 278 | 278 | 290 |
| (° C.) | | | | | | | | |
| extruder zone 2 | 270 | 270 | 270 | 287 | 287 | 287 | 287 | 291 |
| (° C.) | | | | | | | | |
| extruder zone 3 | 269 | 269 | 269 | 291 | 291 | 291 | 291 | 285 |
| (° C.) | | | | | | | | |
| extruder zone 4 | 270 | 270 | 270 | 293 | 293 | 293 | 293 | 280 |
| (° C.) | | | | | | | | |
| extruder flange | 267 | 267 | 267 | 271 | 271 | 271 | 271 | |
| (° C.) | | | | | | | | |
| melt | 282 | 282 | 282 | 297 | 297 | 297 | 297 | 280 |
| temperature | | | | | | | | |
| (° C.) | | | | | | | | |
| extruder speed | 87.7 | 87.7 | 87.7 | 69.0 | 69.0 | 69.0 | 69.0 | 58.6 |
| (rpm) | | | | | | | | |
| extruder | 97 | 97 | 97 | 94 | 94 | 94 | 94 | 93 |
| pressure (bar) | | | | | | | | |
| spinning pump | 28.6 | 28.6 | 28.6 | 21.9 | 21.6 | 21.9 | 21.9 | |
| speed (rpm) | | | | | | | | |
| spin pack melt | 281 | 281 | 281 | 291 | 291 | 291 | 291 | 282 |
| (° C.) | | | | | | | | |
| spin bath | 20 | 20 | 20 | 67 | 67 | 67 | 67 | 70 |
| temperature | | | | | | | | |
| (° C.) | | | | | | | | |
| draw unit 1 | 43.5 | 43.5 | 43.5 | 35.8 | 35.8 | 35.8 | 35.8 | 17.6 |
| (m/min) | | | | | | | | |
| draw unit 2 | 141.9 | 141.9 | 141.9 | 139.8 | 139.8 | 139.8 | 139.8 | 68.4 |
| (m/min) | | | | | | | | |
| draw unit 3 | 180.9 | 180.9 | 180.9 | 196.8 | 196.8 | 196.8 | 196.8 | 99.5 |
| (m/min) | | | | | | | | |
| draw unit 4 | 170.1 | 170.1 | 170.1 | 170.1 | 170.1 | 170.1 | 170.1 | 79.9 |
| (m/min) | | | | | | | | |
| setting duct (° C.) | 225 | 225 | 225 | 195 | 195 | 195 | 195 | 235 |

Table 2 below lists some textile values of the monofils from some of the examples described above:

TABLE 2

| | Example No. | | | | | |
|---|---|---|---|---|---|---|
| | 2 | 3 | 4 | 5 | 6 | 7 |
| linear density (dtex) | 800 | 804 | 977 | 973 | 975 | 5304 |
| free thermal | 10.5 | 10.5 | 10.1 | 10.9 | 10.5 | 3.8 |
| shrinkage 180° (%) | | | | | | |
| ultimate tensile | 40.2 | 44.6 | 41.4 | 43.8 | 41.8 | 195.6 |
| strength (N) | | | | | | |
| tenacity (cN/tex) | 50.3 | 55.5 | 42.4 | 45.1 | 42.9 | 36.9 |
| reference extension | 10.6 | 9.8 | 14.6 | 14.6 | 15.0 | 23.5 |
| at 27 cN/tex (%) | | | | | | |
| elongation at break | 31.8 | 27.9 | 25.5 | 29.6 | 26.1 | 35.2 |
| (%) | | | | | | |
| diameter (μm) | 294 | 300 | 300 | 303 | 301 | 709 |

Table 3 below itemizes the coefficients of friction for the monofils from some of the examples described above:

TABLE 3

| | Example No. | | | | | | | | |
|---|---|---|---|---|---|---|---|---|---|
| | V1 | 2 | 3 | V2 | 4 | 5 | 6 | V3 | 7 |
| monofil | 0.287 | 0.256 | 0.257 | 0.392 | 0.222 | 0.246 | 0.260 | 0.390 | 0.250 |
| on metal, | | | | | | | | | |
| dry | | | | | | | | | |
| monofil | 0.302 | 0.234 | 0.300 | 0.315 | 0.287 | 0.263 | 0.253 | 0.317 | 0.258 |
| on | | | | | | | | | |
| ceramic, | | | | | | | | | |
| wet | | | | | | | | | |

What is claimed is:

1. A monofilament comprising a matrix of thermoplastic polymer and dispersed therein particles of polysiloxane which are from 10 nm to 200 μm in diameter.

2. The monofilament as claimed in claim 1 wherein the particles of polysiloxane are spherical and from 0.2 to 50 μm in diameter.

3. The monofilament as claimed in claim 1, wherein the particles are present at from 0.01 to 8 wt %.

4. The monofilament as claimed in claim 1, wherein the polysiloxane is a linear or crosslinked polysiloxane comprising the repeating structural element —SiR¹R²—O— or is a silsesquioxane of the formula R¹SiO_{3/2}, where R¹ is C₁-C₆-alkyl, in particular methyl, and R² is C₁-C₆-alkyl or phenyl, in particular methyl or phenyl.

5. The monofilament as claimed in claim 4, wherein the polysiloxane is a linear or crosslinked polydimethylsiloxane or a polymethylsilsesquioxane.

6. The monofilament as claimed in claim 1, wherein the thermoplastic polymer is a polyester, a polyamide, a polyether ketone, a polyphenylene sulfide, a polyolefin or a combination of two or more thereof.

7. The monofilament as claimed in claim 6, wherein the thermoplastic polymer is a polyethylene terephthalate, a polybutylene terephthalate, a dicarboxylic acid-modified polyethylene terephthalate, a dicarboxylic acid-modified polybutylene terephthalate, a nylon-6, a nylon-6,6, a nylon-6,10, a nylon-12, a nylon-6,12 or a combination of two or more thereof.

8. The monofilament as claimed in claim 1, further comprising a carbodiimide stabilizer, preferably a polymeric carbodiimide stabilizer.

9. The monofilament as claimed in claim 1, wherein the proportion of thermoplastic polymer is from 60 to 95 wt %, the proportion of polysiloxane is from 0.02 to 8 wt % and the proportion of carbodiimide is from 0 to 10 wt %, wherein the quantitative particulars are based on the overall amount of the monofilament.

10. The monofilament as claimed in claim 1, further comprising from 0.001 to 10 wt % of customary additives, in particular antioxidants, UV stabilizers, fillers, pigments, biocides, electroconductivity enhancers, abrasion resistance enhancers, friction-reducing additives, spin finishes, processing aids, plasticizers, lubricants, delusterants, viscosity modifiers, crystallization accelerants or combinations of two or more thereof.

11. A textile fabric comprising monofilaments as claimed in claim 1, in particular a woven fabric, a loop-drawingly knitted fabric, a loop-formingly knitted fabric, a braided fabric or a non-crimp fabric.

12. A method of using the monofilament as claimed in claim 1 comprising incorporating the monofilament into a papermachine clothing, a conveyor belt or a filtration screen.

13. The method as claimed in claim 12, wherein the papermachine clothing having the monofilament is used in the forming section and/or in the drying section of the papermachine.

14. The monofilament as claimed in claim 2, wherein the particles are present at from 0.01 to 8 wt %.

15. The monofilament as claimed in claim 2, wherein the polysiloxane is a linear or crosslinked polysiloxane comprising the repeating structural element —SiR¹R²—O— or is a silsesquioxane of the formula R¹SiO_{3/2}, where R¹ is C₁-C₆-alkyl, in particular methyl, and R² is C₁-C₆-alkyl or phenyl, in particular methyl or phenyl.

16. The monofilament as claimed in claim 3, wherein the polysiloxane is a linear or crosslinked polysiloxane comprising the repeating structural element —SiR¹R²—O— or is a silsesquioxane of the formula R¹SiO_{3/2}, where R¹ is C₁-C₆-alkyl, in particular methyl, and R² is C₁-C₆-alkyl or phenyl, in particular methyl or phenyl.

17. The monofilament as claimed in claim 15, wherein the polysiloxane is a linear or crosslinked polydimethylsiloxane or a polymethylsilsesquioxane.

18. The monofilament as claimed in claim 16, wherein the polysiloxane is a linear or crosslinked polydimethylsiloxane or a polymethylsilsesquioxane.

19. The monofilament as claimed in claim 2, wherein the thermoplastic polymer is a polyester, a polyamide, a polyether ketone, a polyphenylene sulfide, a polyolefin or a combination of two or more thereof.

20. The monofilament as claimed in claim 3, wherein the thermoplastic polymer is a polyester, a polyamide, a polyether ketone, a polyphenylene sulfide, a polyolefin or a combination of two or more thereof.
